(19) United States
(12) Patent Application Publication
(10) Pub. No.: US 2026/0338614 A1
(43) Pub. Date: Oct. 29, 2026

(54) Computer-implemented method for estimating a rail temperature of the rails of a track section using a track circuit

(71) Applicant: KB Signaling Inc., Grain Valley, MO (US)

(72) Inventors: Eduardo Di Santi, Madrid (ES); Jeffrey Fries, Grain Valley (MO); Francisco Lopez, Madrid (ES); Nenad Mijatovic, Saint Ouen (FR)

(73) Assignee: KB Signaling Inc., Grain Valley, MO (US)

(21) Appl. No.: 19/485,752

(22) PCT Filed: May 25, 2023
(86) PCT No.: PCT/IB2023/000320

§ 371 Date: Nov. 19, 2025

(51) Int. Cl. G01K 7/16; B61K 9/08; B61L 23/04; G01K 7/42; G06N 3/0442; G06N 3/0455

(52) U.S. Cl. CPC G01K 7/16; B61K 9/08; B61L 23/042; G01K 7/42; G06N 3/0442; G06N 3/0455; G01K 2217/00

(57) ABSTRACT

The present invention relates to a computer-implemented method for estimating a temperature of rails (18) of a track section (16) using a track circuit (40) comprising: obtaining track circuit data comprising a plurality of measured currents (I_{TX}, I_{RX}) of a track circuit; obtaining track circuit parameters; transforming the measured currents (I_{TX}, I_{RX}) based on the obtained track circuit parameters and the obtained track circuit data by using a first trained machine-learning model (44), wherein the input of the first trained machine-learning model are the obtained track circuit data and the track circuit parameters and the output of the first trained machine-learning model are the normalized measured currents; and estimating rail temperature using a second machine-learning model (48), wherein the input of the second machine learning model is based on the normalized measured currents and the output of the second machine-learning (48) model is the rail temperature.

### BACKGROUND OF THE DISCLOSURE

The present invention concerns in general to the field or railway systems, and more specifically a computer-implemented method for determining a rail temperature of the rails of a track section using a track circuit.

In view of increased demands to transport goods and passengers by trains an increase of comfortable and reliable railway network is necessary. For the past few decades, railroads have shifted from using jointed rails to using Continuous Welded Rail (CWR) to improve ride comfort for passengers, and to reduce mechanical wear of assets, e.g. tracks, wheels, etc.

However, when using CWR, management of mechanical forces in the rail becomes an increasingly important factor for reliability and safety. These mechanical forces can either be compressive (pushing) or tensile (pulling). If there is too much compressive force, the rail can buckle, e.g. sideways, causing the gauge of the rail to be out of compliance, leaving potential for derailment of a passing train. If there is too much tensile force, the rail can break and pull apart, also leaving potential for derailment of a passing train.

Broken rails are typically detected by existing track circuit technology through an interruption of electric current through the rails. However, buckled rails are not detectable by any state of the art technology. There are, on average, 20 to 50 derailments each year in the USA caused by undetected rail buckles. Many of these derailments have very severe costs and consequences. Rail buckle derailments rank in the top 5 derailment causes based on average frequency and severity.

Therefore, it is a main aim of the present invention to increase the safety of the rail network, by early detection of irregularities of the rails.

This aim is achieved by a method for estimating a temperature of rails of a track section using a track circuit comprising:
obtaining track circuit data comprising a plurality of measured currents of a track circuit;
obtaining track circuit parameters;
transforming the measured currents based on the obtained track circuit parameters and the obtained track circuit data by using a first trained machine-learning model, wherein the input of the first trained machine-learning model are the obtained track circuit data and the track circuit parameters and the output of the first trained machine-learning model are the normalized measured currents; and
estimating rail temperature using a second machine-learning model, wherein the input of the second machine learning model is based on the normalized measured currents and the output of the second machine-learning model is the rail temperature.

According to some embodiments, the method according to the invention may comprise one or more of the following features, which may be combined in any technical feasible combination:
each estimation is based on a predetermined number of samples;
the track circuit parameters include static configuration parameters about the track section, for example a track section length, a rail type, an internal resistance value and/or emitter voltage settings of the track circuit emitter;
the track circuit data includes a transmitted voltage, a received voltage, a transmitted current, a received current, and/or a time stamp.
The transmitted voltage and received voltage are measured on opposed ends of the track section and/or wherein transmitted current and received current are measured on opposed ends of the track section;
the second machine-learning model is at least one of a neural network, in particular a recurrent neural network, a support vector machine and a linear regression;
the first trained machine-learning model is for example a Recurrent Neural Network, in particular implanted as Long Short Term Memory, an AutoEncoder and/or a linear model;
the rail temperature is estimated using the rail resistance calculated by Rrail=2*(Vₜₓ−Vᵣₓ)/(Track Length)*(Iₜₓ +Iᵣₓ) Ohms/ft, wherein Vₜₓ is the transmitted voltage, Iₜₓ is the transmitted current, Vᵣₓ is the received voltage, and Iᵣₓ is received current.

According to an aspect, the present invention relates to a computer-implemented method for determining mechanical forces in the rail, the method comprising: determining the temperature of a rail according to an embodiment disclosed herein; and determining the forces in the rail based on the determined temperature.

Embodiments are also directed to the system for carrying out the disclosed methods steps and in particular including apparatus parts and/or devices for performing described method steps.

According to an aspect, the present invention relates to a control system for detection of the temperature and/or mechanical forces in a rail of a track section, the control system comprising at least one controller configured to perform the method according to an embodiment disclosed herein.

According to an aspect, the present invention relates to a computer-readable medium comprising software code stored therein which, when executed by a processor, executes or initiates the execution of a method according to an embodiment disclosed herein.

The method steps disclosed herein may be performed by way of hardware components, firmware, software, a computer programmed by appropriate software, by any combination thereof or in any other manner.

In particular, for electronic and/or software means, each of the above listed terms means and encompasses electronic circuits or parts thereof, as well as stored, embedded or running software codes and/or routines, algorithms, or complete programs, suitably designed for achieving the technical result and/or the functional performances for which such means are devised.

### BRIEF DESCRIPTION OF THE DRAWINGS

Further characteristics and advantages will become apparent from the description of some preferred but not exclusive exemplary embodiments of a local managing system according to the present disclosure, illustrated only by way of non-limitative examples with the accompanying drawings, wherein:

FIG. 1 shows schematically a system according to an embodiment;

FIG. 2 shows measurements of transmitted (Tx) and received (Rx) currents from opposing ends of a track circuit section;

FIG. 3 shows modules of the machine learning algorithm used in the computer-implemented method;

FIG. 4 shows schematically a block diagram for a method according to an embodiment of the invention;

FIG. 5 shows an estimation error distribution of a period of one year; and

FIG. 6 shows a comparison between the real temperature and the temperature estimated over different time periods throughout a calendar year using a method disclosed herein.

### DETAILED DESCRIPTION OF THE DISCLOSURE

It should be noted that in the detailed description that follows, identical or similar components, either from a structural and/or functional point of view, may have the same reference numerals, regardless of whether they are shown in different embodiments of the present disclosure. It should be also noted that in order to clearly and concisely describe the present disclosure, the drawings may not necessarily be to scale and certain features of the disclosure may be shown in somewhat schematic form.

Further, when the term “adapted” or “arranged” or “configured” or “shaped”, is used herein while referring to any component as a whole, or to any part of a component, or to a combination of components, it has to be understood that it means and encompasses correspondingly either the structure, and/or configuration and/or form and/or positioning. In particular, for electronic and/or software means, each of the above listed terms means and encompasses electronic circuits or parts thereof, as well as stored, embedded or running software codes and/or routines, algorithms, or complete programs, suitably designed for achieving the technical result and/or the functional performances for which such means are devised. In addition, when the term “substantial” or “substantially” is used herein, it has to be understood as encompassing an actual variation of plus or minus 5% with respect to an indicated reference value, device or part thereof, time or position. It should be noted that in the detailed description that follows, identical or similar components, either from a structural and/or functional point of view, have the same reference numerals, regardless of whether they are shown in different embodiments of the present disclosure; it should also be noted that in order to clearly and concisely describe the present disclosure, the drawings may not necessarily be to scale and certain features of the disclosure may be shown in somewhat schematic form.

As stated above the present invention relates to railroads using CWR (Continuous Welded Rail) to improve ride comfort for passengers, and to reduce mechanical wear of assets (track, wheels, etc). However, when using CWR, management of mechanical forces in the rail becomes an increasingly important factor for reliability and safety. These mechanical forces can either be compressive (pushing) or tensile (pulling). If there is too much compressive force, the rail can “buckle” causing the gauge of the rail to be out of compliance, leaving potential for the derailment of a passing train. If there is too much tensile force, the rail can break and pull apart, also leaving potential for the derailment of a passing train. Broken rails are typically detected by existing track circuit technology through an interruption of electric current through the rails.

There are many factors that cause compressive or tensile forces in the rails, but the largest contributor is related to the temperature of the rails. Compressive forces occur when temperatures are high, as the steel rails expand. Tensile forces occur when temperatures are low, as the steel rails contract.

In a typical installation the forces in CWR are managed by controlling the Rail Neutral Temperature (RNT). The RNT is the rail temperature at which there is zero force (neither compressive or tensile). The RNT is set at installation such that the maximum compressive and tensile forces are minimized based on expected rail temperature swings. Even with RNT management processes, rail buckles (and subsequent derailments) continue to occur, so the management alone is not sufficient. Additionally, the RNT can change over time. Changes in RNT can occur due to many factors, including mechanical integrity of the substructure on which the rails lay, anchor points to ties/sleepers, curvature of rails, repeated train passage, and rail repairs. Once rail is installed, there are no practical means available for measuring RNT.

Often railroad operators use the air temperature (after installation) as an estimate of mechanical forces in the rail, based on data from local weather forecasts. If the air temperature will be colder or hotter than some threshold that might lead to excessive tensile or compressive forces in the rails respectively, the railroads will put speed restrictions on the trains in that area. This method of managing risk is not ideal for several reasons, as the weather forecasts are not always accurate in the region of interest, the temperature changes of the rails do not follow the air temperature changes (for example on cloudy days or at night, the rail temperature and air temperature can be similar, whereas on sunny days, the rail temperature can be substantially higher than the air temperature). Sometimes personnel are sent out to physically inspect or measure the temperature of the rails with an infrared thermometer, which increases maintenance costs or temperature sensors may be attached to the rails, which is also expensive.

According to the invention, the track circuit data available from existing track circuits is used to estimate the rail resistance. The rail resistance can be used to estimate the rail temperature, which has, as stated above a direct correlation and is the strongest contributor to forces in the rails. It should also be noted that if the RNT is known (or assumed), the rail forces can also be estimated from the track circuit data.

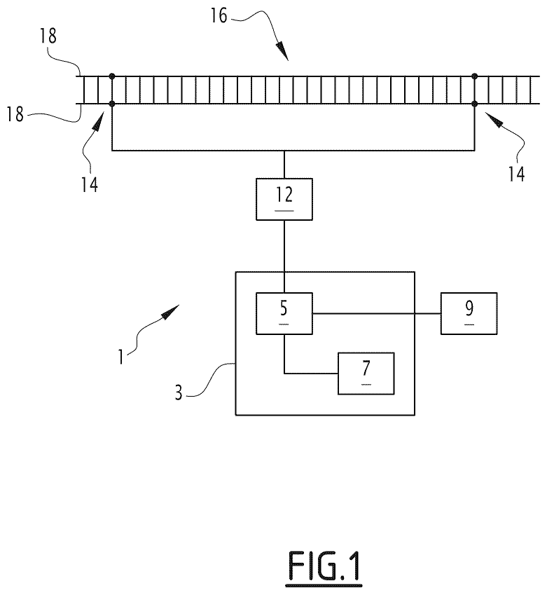

FIG. 1 shows schematically a system 1 according to the invention. The system 1 comprises a controller 3 having at least one processor 5 and a memory 7. The controller 3 is coupled, for example via a physical or wireless connection, to one or more databases 9. The connection between the controller 3 and the at least one database 9 may be also realized via a network, for example the internet.

The controller 3 is further communicatively connected to a track circuit device 12, which is connected to emitters and receivers 14. The track circuit emitters 14 are adapted to emit a current and the track circuit receivers 14 are adapted to receive the emitted current. For example, the track circuit emitters and receivers 14 are arranged respectively at opposite ends of a track section 16 comprising two rails 18. According to embodiments, the track circuit device 12 is arranged close to the track section 16. The emitter 14 injects a current into the rail, which is measured at the emitter 14, for example by the emitter 14, to obtain the transmitted voltage V_{RX} and the transmitted current I_{TX}. At the receiver 14 at the opposite end of the track section 16, the received current I_{RX} and the received voltage V_{RX} are measured, for example by the receiver 14. It should be noted that each end of the track circuit may act as an emitter and receiver, such that both transmitted voltage V_{TX} or current I_{TX} and received voltage V_{RX} or current I_{RX} can be measured from a single end.

The voltages and/or currents are measured at regular time intervals. For example, the sampling rate is in the range of seconds. In other words, the measured voltages V_{TX}, VRX and/or currents I_{TX}, I_{RX} are time stamped. The measured voltages and/or currents V_{TX}, VRX, I_{TX}, I_{RX} provided to the one or more controllers 3 may be the amplitudes of the measured voltages and/or currents V_{TX}, V_{RX}, I_{TX}, I_{RX}.

The controller 3 may be arranged close to the track section 16 or remote to the track section 16.

The resistance of the rails of the track section may be calculated as follows:

Rᵣₐᵢₗ=2(V_{TX}−V_{RX})/(I_{TX}+I_{RX}) [Ohms/ft], with V_{TX} being the transmitted voltage, V_{RX} being the received voltage, I_{TX} being the transmitted current, and I_{RX} being the received current.

As stated above, the rail resistance Rᵣₐᵢₗ correlates strongly to the rail temperature, which correlates strongly to the rail force. According to embodiments, artificial intelligence and machine learning methods are provided to learn this critical correlation and generalize the relationship to any other location with different environmental conditions and track circuit configurations.

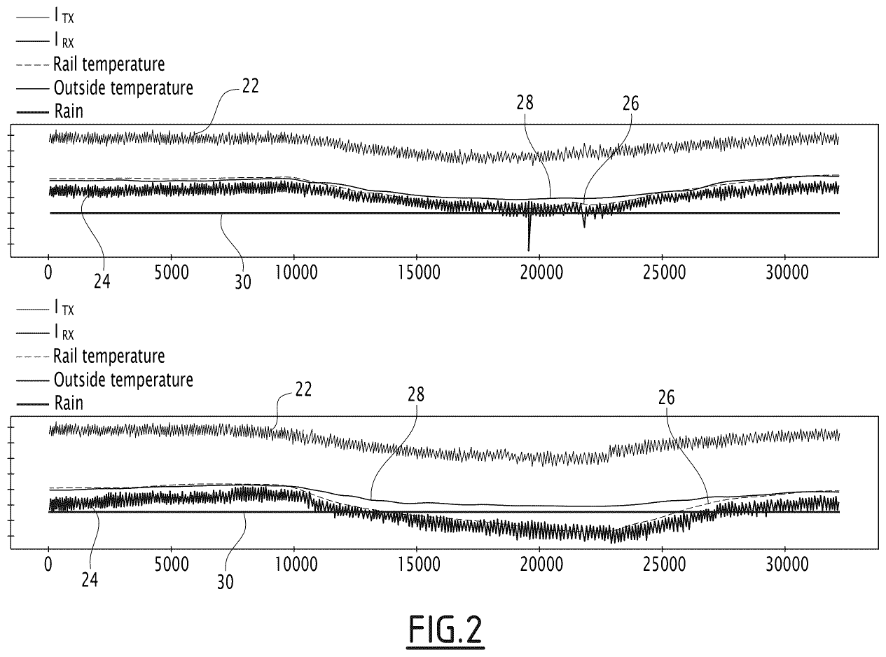

FIG. 2 shows measurements of transmitted (I_{TX}) 22 and received (I_{RX}) 24 currents from opposing ends of a track circuit section 16. The upper graph shows the measurements of a first day and the lower graph shows the measurements of a second day.

In the example of FIG. 2, transmitted (I_{TX}) 22 and received (I_{RX}) 24 currents are presented as amplitudes related with rail and outside temperature. Temperatures are inverted for better understanding of the correlation. The upper plots show the transmitted current I_{TX} 22 of one side of the track circuit, the lower plots show the received current IRX 24 on the other side of the track section 16. The curve 26 shows the rail temperature measured by a sensor installed on the rails. The curve 28 shows the air temperature measured at the site of the track circuit section 16. The curve 30 shows the presence of rain. As it can be seen, there has been no precipitation at all during the measurement period shown in FIG. 2. It should be noted however, that the estimation can also be performed with the track circuit data from one end of the track circuit only.

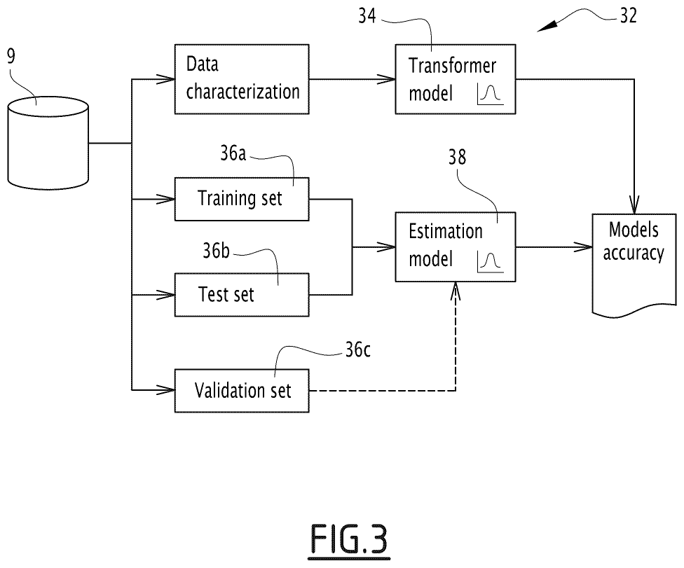

FIG. 3 shows details about modules of the machine-learning algorithm used in the computer-implemented method according to embodiments, for example implemented in the controller 3, in particular during the training of the machine learning algorithm.

According to embodiments, the track circuit device 12 provides track circuit data, which includes the measured voltages and/or currents V_{TX}, V_{RX}, I_{TX}, I_{RX} with respective time stamps. Further, there are provided track circuit parameters (not shown). The track circuit parameters include static configuration parameters about the track section, for example the track section length, a rail type, an internal resistance value, emitter voltage settings of the track circuit emitter and/or the like. For example the rail type indicates the cross sectional area of a rail. The internal resistance value is all the location specific resistance that includes the wiring between a transmitter and/or receiver and the rails of the track section. Additionally or alternatively, the track circuit data and the track circuit parameters are stored in one or more databases 9 and obtained from such databases, as shown in FIG. 3.

At a first step, a predetermined number of k samples of track circuit data is gathered. k represents the width of a sliding window, which comprises k number of samples. In an embodiment, every 1 to 5 seconds the track circuit data is collected, in particular every 3 seconds. For example, a sliding window may include between 10 and 1200 consecutive samples. In an embodiment, the number of samples correspond to 30 seconds to 1 hour. For example, the samples of track circuit data may be gathered by the controller 3 and/or by the track circuit device 12. According to embodiments, the k samples of track circuit data are ordered in a time and may form a vector (\vec{ν})={[I_{TX}, I_{RX}]ₜ₀, [I_{TX}, I_{RX}]ₜ₀, . . . . [I_{TX}, I_{RX}]ₜₖ}, where I_{TX} and I_{RX} are the transmitted and received currents respectively and the subindex t corresponds to the time offset from 0 to k of the respective sample. In addition, the transmitted and/or received voltages V_{TX}, V_{RX}, may be added to the vector as additional dimension.

In some embodiments, in particular prior to the training of the first machine-learning model, the track circuit data is modified by removing the mean value, in particular over the window length of k samples, of the track circuit data from each data point and divide it with the standard deviation. This enables to remove any bias associated with the specific parameters (transmitted gain, length of the track circuit, etc) of the track circuits.

According to embodiments, a characterization process 32 builds a first machine-learning model 34, in particular comprising a transformer model, capable to transform the track circuit data, in particular the measured voltages and/or currents V_{TX}, V_{RX}, I_{TX}, I_{RX} based on the specific track circuit parameters into normalized track circuit data, in particular normalized measured current data. The track circuit data may be provided in form of a vector with the k samples, in order to build the first machine-learning model. The transformer model is implemented as a first machine-learning model 34, which takes the track circuit parameters into consideration when transforming the data, in particular the measured voltages and/or currents V_{TX}, V_{RX}, I_{TX}, I_{RX} from one track circuit data to a normalized track circuit data.

The first machine-learning model 34 is for example an RNN (Recurrent Neural Network), implanted as LSTM (Long Short Term Memory), an AutoEncoder, a linear model, but not limited to any particular method.

In a next step, the normalized track circuit data, in particular the normalized measured current data, is separated into training 36a, testing 36b and validation (data) 36c sets in order to train a second machine-learning model 38, in particular the estimation neural network building the estimator model. Training and test set 36a, 36b are datasets taken from real data in order to describe the phenomena using machine-learning method(s) according to the invention. The validation set 36c is a set of data that are unknown to the machine learning algorithms and are used to validate the model's accuracy and predict its behaviour in production.

The normalized track circuit data includes, for the training, in addition also the measured rail temperature, using for example an infrared meter or thermometer. Optionally, the data for the training of the second machine-learning model includes the calendar date and/or historical weather data based on the geo-location of the track section 16.

In an embodiment, the second machine-learning model 38 (estimation model) is an RNN, but not limited to, using the normalized track circuit data and estimating the rail temperature. A RNN (Recurrent Neural Network) is a type of a Neural Network where connections between nodes can create a cycle, allowing output from some nodes to affect subsequent input to the same nodes. A neural network comprises a plurality of node layers, comprising an input layer, one or more hidden layers and an output layer. Each node connects to another node and has an associated weight and threshold value. If the output of any individual node is above the defined threshold value, that node is activated, sending data to the next layer of the network. This results in the output of one node becoming in the input of the next node. If the output is below the threshold value, no data is passed to the next layer of the neural network. In case of supervised learning, labeled data set are used, like in the present embodiment. At the output, an error or cost function is calculated and subsequently the weights and the thresholds of the nodes are adapted in order to minimize the error. In other embodiments, the model may be trained through backpropagation, which enables to calculate the error associated with each neuron in order to adapt respectively the weights a threshold of the nodes.

In other embodiments, other machine learning models may be used as a second machine learning model 38. For example, SVM (Support Vector Machine) models, linear regression models, standard neural networks and other machine learning/artificial intelligence models may be used.

For example, measured temperatures, for example the ones shown in FIG. 2, are used in order to train the second machine-learning model, for example in form of the neural network or the RNN.

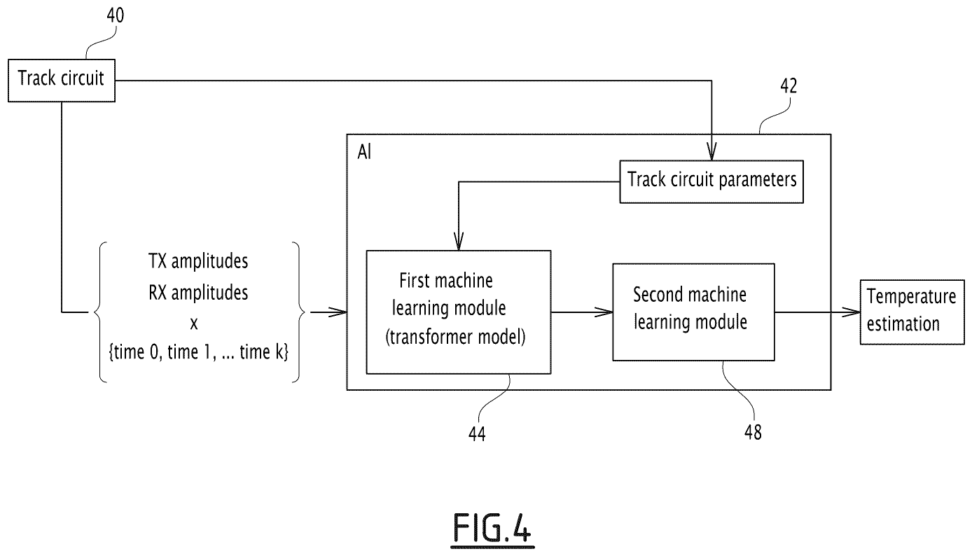

FIG. 4 shows schematically a block diagram for a method according to an embodiment of the invention, in particular for determining a rail temperature and/or the mechanical forces of the rails. The method may be performed by one or more controllers 3. Block 40 is a track circuit device, for example in form of the track circuit device 12 of FIG. 1. The track circuit device 40 provides for example the track circuit data, in particular the measured voltages and/or currents V_{TX}, V_{RX}, I_{TX}, I_{RX}, and/or the corresponding time stamp, and/or the track circuit parameters to the controller 3 In other embodiments, the track circuit data and/or the track circuit parameters are obtained from the at least one database 9. In other embodiments the track circuit parameters may be stored in the controller 3 or in the at least one database 9. For example, in an embodiment a user may provide the track circuit parameters to the controller 3.

At a first step, a predetermined number k of samples of track circuit data is gathered. k represents the width of a sliding window, which comprises k number of samples. In an embodiment, every 1 to 5 seconds the track circuit data is collected, in particular every 3 seconds. For example, a sliding window may include between 10 and 1200 consecutive samples. In an embodiment, the number of samples correspond to 30 seconds to 1 hour. For example, the samples of track circuit data may be gathered by the controller 3 and/or by the track circuit device 12 or 40. According to embodiments, the k samples of track circuit data are ordered in a time and may form a vector (\vec{ν})={[I_{TX}, I_{RX}]ₜ₀, [I_{TX}, I_{RX}]ₜ₀, . . . . [I_{TX}, I_{RX}]ₜₖ}, where I_{TX} and I_{RX} are the transmitted and received currents respectively and the subindex t corresponds to the time offset from 0 to k of the respective sample. According to embodiments, a sliding window of k samples is used. In addition, the transmitted and/or received voltages V_{TX}, V_{RX}, may be added to the vector as additional dimension.

In some embodiments, which may be combined with other embodiments disclosed herein, in particular prior to providing the track circuit data to the first trained machine-learning model, the track circuit data, in particular each vector (\vec{ν}), is modified by removing the mean value, in particular over the window length of k samples, of the track circuit data from each data point and divide it with the standard deviation. This enables to remove any bias associated with the specific parameters (transmitted gain, length of the track circuit, etc) of the track circuits.

Block 42 shows schematically the different modules of the machine learning or artificial intelligence algorithm.

In a first module 44, the first trained machine-learning module adapts transforms the track circuit data to normalized track circuit data based on the track circuit parameters. The transformer model, in particular the first machine-learning model, is used in the first trained machine-learning module 44. The vectors are transformed in order to generate normalized track circuit data, in particular normalized transmitted and received current data.

Generally, artifacts are used to describe the first machine-learning model or a machine learning model in general. The artifacts may include for example the model definition, parameters and/or hyper-parameters, after the first machine-learning model gets trained and validated. Hyper-parameters are parameters of the machine-learning model.

Then, the transformed track circuit data, in particular the transformed track circuit current data, for example in form of a vector \vec{ν}, is used as input of the block 48, the second machine-learning module, including the second machine-learning model, for example a neural network with an output layer to perform the estimation of the temperature. In other words, the second machine-learning model in block 48 performs the temperature estimation. For example, the neural network is an RNN (Recurrent Neural Network). The temperature can be used to determine the mechanical forces in the rails 18.

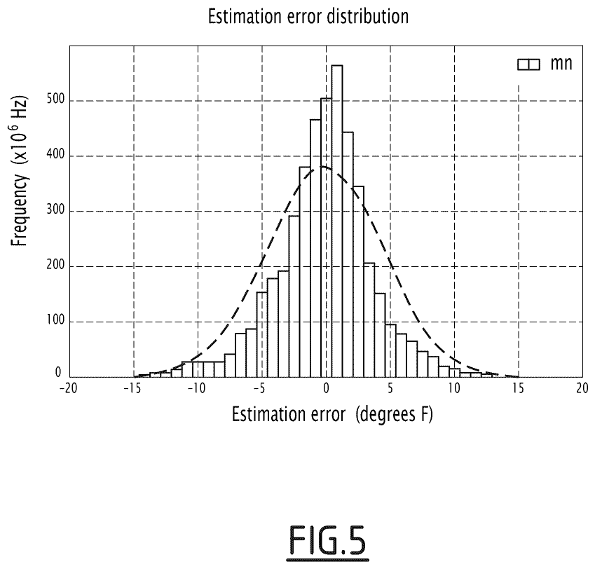

FIG. 5 shows an estimation error distribution of a period of one year for estimating the rail temperature, in particular for all seasons and all conditions. Overall, the confidence level is +/−5 °F in 95% of the cases.

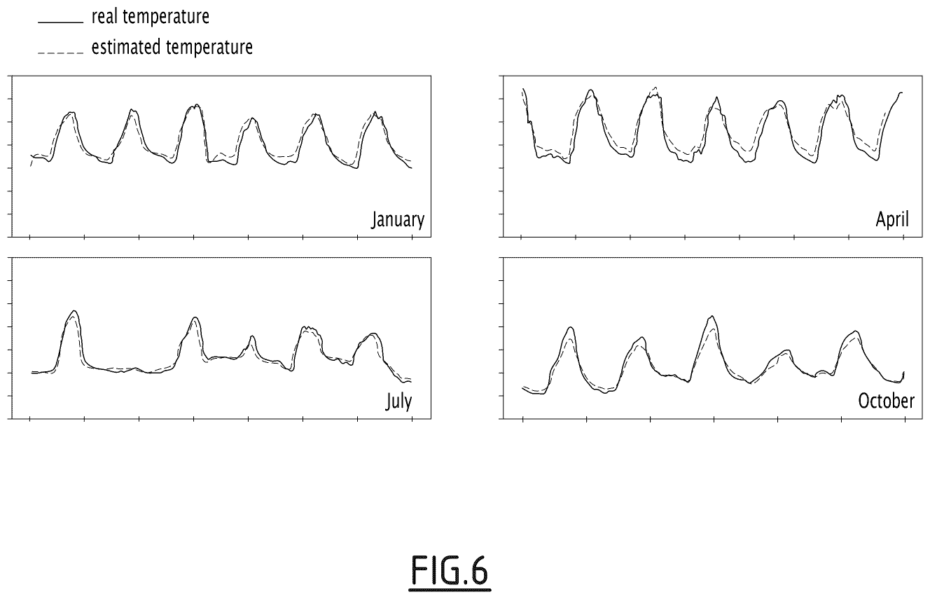

FIG. 6 shows in each diagram a comparison between the real temperature and the temperature estimated using a method disclosed herein, in particular using machine learning. The different plots indicate the temperature accuracy throughout different climatic periods of the year as shown. As it can be seen, the difference between the estimated temperature and the real temperature is rather low. Confidence levels are very high and the underestimation/overestimation is marginal.

According to the invention, data available from existing track circuits is used to estimate the rail resistance, which can be used to estimate the rail temperature, which has a direct correlation and is the strongest contributor to rail forces. In most cases, the track circuits already exist which makes the solution economically feasible as no sensors are required. The invention provides real time visibility of the rail temperature and forces without relying on errors from using inaccurate weather forecasts and does not require maintenance personnel to physically take measurements on the rails.

1. A method for estimating a temperature of rails (18) of a track section (16) using a track circuit (40) comprising:
obtaining track circuit data comprising a plurality of measured currents (ITX, IRX) of a track circuit; obtaining track circuit parameters;
transforming the measured currents (ITX, IRX) based on the obtained track circuit parameters and the obtained track circuit data by using a first trained machine-learning model (44), wherein the input of the first trained machine-learning model are the obtained track circuit data and the track circuit parameters and the output of the first trained machine-learning model are the normalized measured currents; and
estimating rail temperature using a second machine-learning model (48), wherein the input of the second machine learning model is based on the normalized measured currents and the output of the second machine-learning (48) model is the rail temperature.

2. The method according to claim 1, wherein each estimation is based on a predetermined number of samples.

3. The method according to claim 1, wherein the track circuit parameters include static configuration parameters about the track section, for example a track section length, a rail type, an internal resistance value and/or emitter voltage settings of the track circuit emitter.

4. The method according to claim 1 wherein the track circuit data includes a transmitted voltage, a received voltage, a transmitted current, a received current, and/or a time stamp.

5. The method according to claim 4, wherein the transmitted voltage (V_{TX}) and received voltage (V_{RX}) are measured on opposed ends of the track section (16) and/or wherein transmitted current (ITX) and received current (I X) are measured on opposed ends of the track section (16).

6. The method according to claim 1, wherein the second machine-learning model (48) is at least one of a neural network, in particular a recurrent neural network, a support vector machine and a linear regression.

7. The method according to claim 1, wherein the first trained machine-learning model (44) is for example a Recurrent Neural Network, in particular implanted as Long Short Term Memory, an AutoEncoder and/or a linear model.

8. The method according to claim 1, wherein the rail temperature is estimated using the rail resistance calculated by
Rrail=2*(Vₜₓ−Vᵣₓ)/(Track Length)*(lₜₓ+Iᵣₓ) Ohms/ft
wherein Vₜₓ is the transmitted voltage, lₜₓ is the transmitted current, Vᵣₓ is the received voltage, and lᵣₓ is received current.

9. (canceled)

10. A control system (1) for detection of the temperature and/or mechanical forces in a rail of a track section (16), the control system comprising at least one controller (3) configured to perform the method according to claim 1.

11. A computer-readable medium comprising software code stored therein which, when executed by a processor, executes or initiates the execution of a method according to claim 1.
